(19) United States
(12) Patent Application Publication
(10) Pub. No.: US 2006/0170663 A1
(43) Pub. Date: Aug. 3, 2006

(54) Analog/digital recording and playback device, and display device

(75) Inventors: Yoshitaka Mouri, Echizen-city (JP); Takehiko Igarashi, Echizen-city (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ORION ELECTRIC CO., LTD., Echizen-city (JP)

(21) Appl. No.: 11/334,569

(22) Filed: Jan. 19, 2006

(30) Foreign Application Priority Data
Jan. 31, 2005 (JP) 2005-024346

(51) Int. Cl. G09G 5/00

(52) U.S. Cl. 345/204

(57) ABSTRACT

An analog/digital recording and playback device and display device which reduce influences of noise between a digital circuit block and analog circuit block to the lowest possible level are provided. A main substrate constituting an analog circuit block which controls an analog signal received from analog broadcasting and an IP conversion circuit substrate constituting a digital circuit block which controls a digital signal received from digital broadcasting are provided inside a housing of a recording and playback device, the main substrate and IP conversion circuit substrate are arranged in parallel and ends thereof are connected as one piece. A shielded substrate for separating the main substrate from the IP conversion circuit substrate is provided in the neighborhood of a joint where the ends are connected. This suppresses noise interference between the main substrate and IP conversion circuit substrate.

The present application is based on and claims priority of Japanese patent application No. 2005-024346 filed on Jan. 31, 2005, the entire contents of which are hereby incorporated by reference.

### BACKGROUND OF THE INVENTION

1. Field of the Invention

The present invention relates to an analog/digital recording and playback device and an analog/digital display device which allow signals of not only conventionally used analog broadcasting but also digital broadcasting to be input, and more particularly, to an analog/digital recording and playback device and display device with a main substrate constituting an analog circuit block and a sub substrate constituting a digital circuit block attached to this main substrate, both of which are provided for such devices and arranged so as not to be mutually influenced by noise interference.

2. Description of the Related Art

In order to achieve commonality and downsizing of a substrate, when a digital circuit block and an analog circuit block are mixed and arranged in a single device, such a device conventionally adopts a structure in which the digital circuit block and analog circuit block are arranged on different substrates or an upright substrate constituting the digital circuit block is disposed upright so as to be perpendicular to a main substrate constituting the analog circuit block which is horizontally disposed so that these substrates do not overlap each other in parallel in the same direction to thereby prevent the respective substrates from being mutually influenced by noise interference.

Because of purchasers' demands, housings of recording and playback devices are being increasingly downsized in recent years, yet since the downsizing causes space in the housing to be reduced, if a digital circuit block and an analog circuit block are arranged on a single substrate, the digital circuit block and analog circuit block must be arranged close to each other in the downsized device, and the arrangement of these devices close to each other may cause mutual noise interference. Furthermore, when the space occupied by the substrate of the digital circuit block cannot help but be increased for structure-related reasons, a countermeasure is taken such that a space above the substrate of the digital circuit block is used to place another substrate above this substrate, but when these substrates are arranged in such a way as to overlap each other in parallel, they are mutually influenced by noise interference, and therefore there is a limitation to the arrangement of the substrate of the digital circuit block close to the substrate of the analog circuit block.

As an invention related to such a conventional technology, Japanese Patent Laid-Open Publication No. 5-13134 (patent document 1) discloses a multiple mounting device which mounts a plurality of sub substrates in parallel above a main substrate in vertical direction and Japanese Patent Laid-Open Publication No. 2001-266977 (patent document 2) discloses a structure in which a sub substrate is mounted perpendicular to main substrates which are arranged in parallel.

However, the patent document 1 describes no more than a technology of mounting a plurality of sub substrates in parallel above a main substrate to thereby improve a parts mounting rate of the main substrate and the arrangement of the plurality of substrates which overlap one another in parallel may cause these substrates to produce noise interference. Furthermore, the patent document 2 discloses a structure in which a sub substrate is held sandwiched between main substrates using a fixture, but it neither discloses nor suggests any structure in which a plurality of substrates that contain both digital circuit blocks and analog circuit blocks are arranged in a device to prevent noise interference between blocks.

### SUMMARY OF THE INVENTION

The present invention has been implemented in view of the above described circumstances of the background arts and it is an object of the present invention to provide an analog/digital recording and playback device, and display device which reduce influences of noise and radiations between digital circuit blocks and analog circuit blocks to the lowest possible level.

The analog/digital recording and playback device according to a first aspect of the present invention is an analog/digital recording and playback device which can receive signals from analog broadcasting and digital broadcasting, the recording and playback device comprising inside a housing thereof a main substrate constituting an analog circuit block which controls an analog signal received from analog broadcasting and a sub substrate constituting a digital circuit block which controls a digital signal received from digital broadcasting, wherein the main substrate and sub substrate are arranged in parallel, ends of the main substrate and sub substrate are connected as one piece and a shielded substrate which separates the analog circuit block from the digital circuit block is provided in the neighborhood of a joint where the ends are connected.

According to the first aspect, the shielded substrate can reduce noise interference and radiations between the analog circuit block and digital circuit block.

The analog/digital recording and playback device according to a second aspect of the present invention is the analog/digital recording and playback device according to the first aspect, wherein the main substrate and sub substrate are disposed horizontally and the shielded substrate is disposed vertically.

According to the second aspect, the shielded substrate vertically separates the horizontally disposed analog circuit block of the main substrate from the digital circuit block of the sub substrate, and can thereby reduce noise interference and radiations therebetween.

The analog/digital recording and playback device according to a third aspect of the present invention is the analog/digital recording and playback device according to the first or second aspect, wherein connectors or connection pins provided for the shielded substrate as one piece are coupled with connection pins or connectors provided for the main substrate as one piece.

According to the third aspect, connectors and connection pins can be coupled, which facilitates attachment/detachment of the shielded substrate to/from the main substrate without taking much time as in the case of screwing which is generally used.

The analog/digital display device according to a fourth aspect of the present invention is an analog/digital display device which can receive signals from analog broadcasting and digital broadcasting, the display device comprising inside a housing thereof a main substrate constituting an analog circuit block which controls an analog signal received from analog broadcasting and a sub substrate constituting a digital circuit block which controls a digital signal received from digital broadcasting, wherein the main substrate and sub substrate are arranged in parallel, ends of the main substrate and sub substrate are connected as one piece and a shielded substrate which separates the analog circuit block from the digital circuit block is provided in the neighborhood of a joint where the ends are connected.

According to the fourth aspect, the shielded substrate can reduce noise interference and radiations between the analog circuit block and digital circuit block.

The analog/digital display device according to a fifth aspect of the present invention is the analog/digital display device according to the fourth aspect, wherein the main substrate and sub substrate are disposed horizontally and the shielded substrate is disposed vertically.

According to the fifth aspect, the shielded substrate vertically separates the horizontally disposed analog circuit block of the main substrate from the digital circuit block of the sub substrate, and can thereby reduce noise interference and radiations therebetween.

The analog/digital display device according to a sixth aspect of the present invention is the analog/digital display device according to the fourth or fifth aspect, wherein connectors or connection pins provided for the shielded substrate as one piece are coupled with connection pins or connectors provided for the main substrate as one piece.

According to the sixth aspect, connectors and connection pins can be coupled, which facilitates attachment/detachment of the shielded substrate to/from the main substrate without taking much time as in the case of screwing which is generally used.

### BRIEF DESCRIPTION OF THE DRAWINGS

FIG. 1 illustrates a recording and playback device according to an embodiment of the present invention viewed from above; and

FIG. 2 is an exploded perspective view of principal parts of the recording and playback device according to the embodiment.

### DETAILED DESCRIPTION OF THE PREFERRED EMBODIMENTS

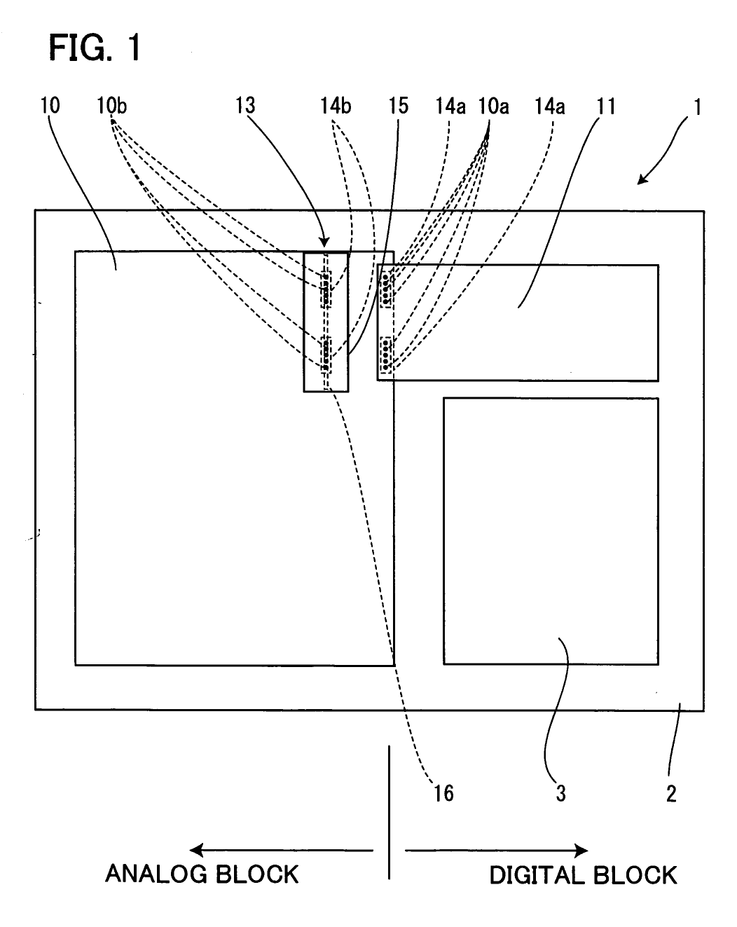

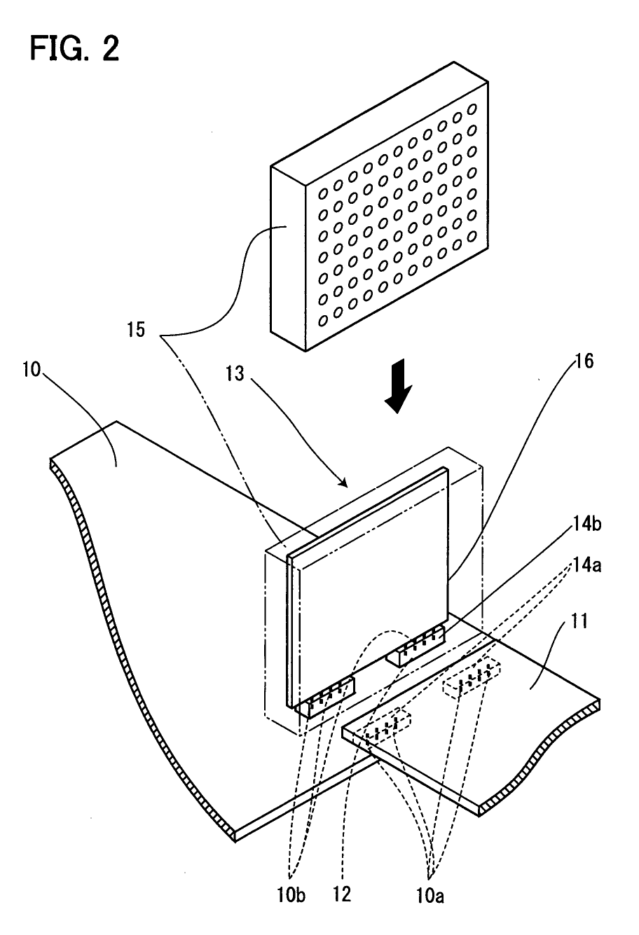

An embodiment as the best mode for implementing the present invention will be explained based on FIG. 1 and FIG. 2 below. However, it goes without saying that the present invention is also easily applicable to structures other than that explained in the embodiment within a range not departing from the essence of the present invention.

FIG. 1 illustrates a recording and playback device which can record/play back data to/from an optical disk viewed from above and FIG. 2 is an exploded perspective view of principal parts of the recording and playback device.

A recording and playback device 1 performs control such as display control of signals from analog broadcasting and digital broadcasting on a display device, recording or playback, and the whole body thereof is constructed of a box-like housing 2, an optical disk device 3 which can record/playback data to/from an optical disk is fixed to one side, or the front side (right side in FIG. 1) of the interior of the housing 2 using screws or the like and an IP conversion circuit substrate which will be described later is disposed therebehind.

Furthermore, a main substrate 10 constituting an analog circuit block which controls signals received from analog broadcasting is disposed horizontally on the other side facing the above described one side (left side in FIG. 1), an IP conversion circuit substrate 11 as a sub substrate constituting a digital circuit block which controls signals received from analog broadcasting is disposed horizontally next to this main substrate 10, the main substrate 10 and IP conversion circuit substrate 11 are disposed parallel to each other, but these sections as a whole are not arranged mutually facing each other, the IP conversion circuit substrate 11 is attached so as to protrude outward in the lateral direction of the main substrate 10 and this protruding part of the IP conversion circuit substrate 11 constitutes the digital circuit block. By arranging substantially the whole bodies of the main substrate 10 and IP conversion circuit substrate 11 partitioned, that is, by keeping a distance between the digital circuit block and analog circuit block and providing a partition between the blocks in the housing 2 when carrying out recording, playback or display control of digital signals, it is possible to reduce mutual noise interference and radiations between the main substrate 10 and IP conversion circuit substrate 11 arranged inside the housing 2 or reduce interference with a VCR playback head or the like in the case of a composite machine including a main microcomputer of the analog circuit block, analog audio/video processing circuit and VCR. In this embodiment, the IP conversion circuit substrate 11 constituting the digital circuit block is disposed horizontally and attached to the main substrate 10 constituting the analog circuit block so that the analog circuit block and digital circuit block can be separated on the left and right inside the housing 2 and if the two parts are partitioned, for example, by a shielded substrate 13 at the center between the two, the two parts can be completely separated on the left and right to thereby eliminate noise.

Furthermore, as shown in FIG. 2, this embodiment includes connection pins 10a, 10b protruding from the top surface of the main substrate 10, allows the IP conversion circuit substrate 11 and shielded substrate 13 to be easily fixed to the main substrate 10 by coupling the connection pins 10a, 10b with connectors 14a, 14b provided as one piece for the IP conversion circuit substrate 11 and shielded substrate 13 respectively, disposes a shielded substrate 13 of HDMI (High-Definition Multimedia Interface) in the neighborhood of a joint 12 between the main substrate 10 and IP conversion circuit substrate 11 fixed and connected by the connection pins 10a and connectors 14a in an upright position, arranges the analog circuit block and digital circuit block partitioned by the shielded substrate 13, and can thereby prevent influences of mutual noise interference and radiations between the analog circuit block and digital circuit block. As shown in FIG. 2, the shielded substrate 13 disposed upright in the neighborhood of the joint 12 can be fixed by coupling the connection pins 10b with the connectors 14b on the top surface of the main substrate 10, that is, the IP conversion circuit substrate 11 and a substrate 16 inside the shielded substrate 13 can be simply fixed to the main substrate 10 as one piece in a so-called pin-compatible manner. The connectors 14a, 14b are provided with connection holes (not shown) which allow the connection pins 10a, 10b to be fitted in or pulled out, and therefore it is possible to easily attach/detach the IP conversion circuit substrate 11 and shielded substrate 13 to/from the main substrate 10. Not only the shielded substrate 13, but also, for example, the IP conversion circuit substrate (sub substrate) 11 of the digital circuit block may also be freely replaced by other digital substrates such as a substrate dedicated to a digital tuner (not shown) or a substrate dedicated to digital input/output in a pin-compatible manner and enhancing commonality of the substrate with other models can reduce costs.

Furthermore, a shield 15 formed on the shielded substrate 13 to prevent noise interference and radiations is the shield 15 for preventing noise and radiations attached so as to cover the entire substrate 16 as shown in FIG. 2.

This embodiment realizes connections between the substrates 10, 11, 13 by coupling the connection pins 10a, 10b provided for the main substrate 10 as one piece with the connectors 14a, 14b of the IP conversion circuit substrate 11 and shielded substrate 13, but the present invention is not limited to this and the IP conversion circuit substrate 11 and shielded substrate 13 can also be attached to the main substrate 10 as one piece by providing the connection pins 10a, 10b for the IP conversion circuit substrate 11 and shielded substrate 13 respectively as one piece and providing the connectors 14a, 14b corresponding thereto for the main substrate 10 as one piece.

Furthermore, the recording and playback device 1 is, for example, a DVD device, HDD device, D-VIDEO device and it goes without saying that it is also applicable to an analog/digital display device which displays video such as a television, liquid crystal television, PDP device and projection television if it has at least a similar structure and a variety of types of modification are available, for example, a composite machine which combines these devices.

As described above, the analog/digital recording and playback device or analog/digital display device according to the present invention is provided with the main substrate 10 constituting an analog circuit block which controls an analog signal received from analog broadcasting and an IP conversion circuit substrate 11 which is a sub substrate constituting a digital circuit block which controls a digital signal received from digital broadcasting in the housing 2 of the recording and playback device 1 and display device, arranges the main substrate 10 and IP conversion circuit substrate 11 in parallel, connects the ends of the main substrate 10 and IP conversion circuit substrate 11 as one piece, provides the substrate 16 which provides a partition between the analog circuit block of the main substrate 10 and the digital circuit block of the IP conversion circuit substrate 11 using a shielded substrate 13 which covers the shield 15 for preventing noise interference and radiations in the neighborhood of the joint 12 where the main substrate 10 and IP conversion circuit substrate 11 are connected, and can thereby reduce influences of noise interference and radiations between the analog circuit block and digital circuit block using this shielded substrate 13.

Furthermore, the main substrate 10 and IP conversion circuit substrate 11 are disposed horizontally in the housing 2 and the shielded substrate 13 is disposed vertically, and the horizontally disposed analog circuit block of the main substrate 10 and the digital circuit block of the IP conversion circuit substrate 11 are partitioned using the vertically disposed shielded substrate 13, and it is thereby possible to avoid a plurality of substrates from being arranged facing each other as in the case of the conventional art, reduce noise interference and radiations and suppress influences of noise interference and radiations.

Furthermore, the connectors 14a, 14b or connection pins 10a, 10b provided for the shielded substrate 13 as one piece are coupled with the connection pins 10a, 10b or connectors 14a, 14b provided for the main substrate 10 as one piece for attachment, which allows simple attachment or detachment by insertion or removal without taking time for screwing or the like which is generally used and facilitates the work of attaching the shielded substrate 13 for suppressing noise and radiations to the main substrate 10.

The analog/digital recording and playback device according to the first aspect of the present invention is an analog/digital recording and playback device which can receive signals from analog broadcasting and digital broadcasting, the recording and playback device comprising inside a housing thereof a main substrate constituting an analog circuit block which controls an analog signal received from analog broadcasting and a sub substrate constituting a digital circuit block which controls a digital signal received from digital broadcasting, wherein the main substrate and sub substrate are arranged in parallel, ends of the main substrate and sub substrate are connected as one piece and a shielded substrate which separates the analog circuit block from the digital circuit block is provided in the neighborhood of a joint where the ends are connected, and can thereby reduce influences of noise and radiations between the digital circuit block and analog circuit block to the lowest possible level.

The analog/digital recording and playback device according to the second aspect of the present invention is the analog/digital recording and playback device according to the first aspect, wherein the main substrate and sub substrate are disposed horizontally and the shielded substrate is disposed vertically, and can thereby suppress influences of noise interference and radiations.

The analog/digital recording and playback device according to the third aspect of the present invention is the analog/digital recording and playback device according to the first or second aspect, wherein connectors or connection pins provided for the shielded substrate as one piece are coupled with connection pins or connectors provided for the main substrate as one piece, and can thereby easily couple the shielded substrate for suppressing noise and radiations with the main substrate.

The analog/digital display device according to the fourth aspect of the present invention is an analog/digital display device which can receive signals from analog broadcasting and digital broadcasting, the display device comprising inside a housing thereof a main substrate constituting an analog circuit block which controls an analog signal received from analog broadcasting and a sub substrate constituting a digital circuit block which controls a digital signal received from digital broadcasting, wherein the main substrate and sub substrate are arranged in parallel, ends of the main substrate and sub substrate are connected as one piece and a shielded substrate which separates the analog circuit block from the digital circuit block is provided in the neighborhood of a joint where the ends are connected, and can thereby reduce noise and radiations between the digital circuit block and analog circuit block to the lowest possible level.

The analog/digital display device according to the fifth aspect of the present invention is the analog/digital display device according to the fourth aspect, wherein the main substrate and sub substrate are disposed horizontally and the shielded substrate is disposed vertically, and can thereby suppress influences of noise interference and radiations.

The analog/digital display device according to the sixth aspect of the present invention is the analog/digital display device according to the fourth or fifth aspect, wherein connectors or connection pins provided for the shielded substrate as one piece are coupled with connection pins or connectors provided for the main substrate as one piece, and can thereby easily couple the shielded substrate for suppressing noise and radiations with the main substrate.

What is claimed is:

1. An analog/digital recording and playback device which can receive signals from analog broadcasting and digital broadcasting, the recording and playback device comprising inside a housing thereof:
a main substrate constituting an analog circuit block which controls an analog signal received from analog broadcasting; and
a sub substrate constituting a digital circuit block which controls a digital signal received from digital broadcasting,
wherein the main substrate and sub substrate are arranged in parallel, ends of the main substrate and sub substrate are connected as one piece and a shielded substrate which separates the analog circuit block from the digital circuit block is provided in the neighborhood of a joint where the ends are connected.

2. The analog/digital recording and playback device according to claim 1, wherein the main substrate and sub substrate are disposed horizontally and the shielded substrate is disposed vertically.

3. The analog/digital recording and playback device according to claim 1, wherein connectors or connection pins provided for the shielded substrate as one piece are coupled with connection pins or connectors provided for the main substrate as one piece.

4. The analog/digital recording and playback device according to claim 2, wherein connectors or connection pins provided for the shielded substrate as one piece are coupled with connection pins or connectors provided for the main substrate as one piece.

5. An analog/digital display device which can receive signals from analog broadcasting and digital broadcasting, the display device comprising inside a housing thereof:
a main substrate constituting an analog circuit block which controls an analog signal received from analog broadcasting; and
a sub substrate constituting a digital circuit block which controls a digital signal received from digital broadcasting,
wherein the main substrate and sub substrate are arranged in parallel, ends of the main substrate and sub substrate are connected as one piece and a shielded substrate which separates the analog circuit block from the digital circuit block is provided in the neighborhood of a joint where the ends are connected.

6. The analog/digital display device according to claim 5, wherein the main substrate and sub substrate are disposed horizontally and the shielded substrate is disposed vertically.

7. The analog/digital display device according to claim 5, wherein connectors or connection pins provided for the shielded substrate as one piece are coupled with connection pins or connectors provided for the main substrate as one piece.

8. The analog/digital display device according to claim 6, wherein connectors or connection pins provided for the shielded substrate as one piece are coupled with connection pins or connectors provided for the main substrate as one piece.
